(19) United States
(12) Patent Application Publication
(10) Pub. No.: US 2008/0278281 A1
(43) Pub. Date: Nov. 13, 2008

(54) Safety edge system with override of fault condition

(76) Inventors: Eric Lavin, Burlington, NJ (US); David Charles Guthrie, Chester Springs, PA (US); Bernd Kagerer, Lawrenceville, NJ (US)

Correspondence Address: MATHEWS, SHEPHERD, MCKAY, & BRUNEAU, P.A., 29 THANET ROAD, SUITE 201, PRINCETON, NJ, 08540, US

(21) Appl. No.: 12/080,739

(22) Filed: Apr. 4, 2008

Related U.S. Application Data
(60) Provisional application No. 60/922,053, filed on Apr. 5, 2007.

(51) Int. Cl. G08C 19/00

(52) U.S. Cl. 340/5.7

(57) ABSTRACT

A method, system and apparatus for operating a safety sensitive edge for the safeguarded motor-driven movement of a door or gate having a moving edge is provided. An external sensing device(s) arranged in a feedback loop is disposed proximate the moving edge of the door and generates a fault signal when an obstruction is detected or when components of the feedback loop have systemically failed. A user indicates a desire to move the door by selecting a button, which generates a depressed signal while the button is depressed. The status of these signals is provided to a controller. In the absence of the fault signal, the controller generates an output signal indicating safe movement of the door is possible. If the fault signal is present, the controller generates an output signal indicating safe movement of the door is possible when the depressed signal is provided to the controller.

### CROSS REFERENCE TO RELATED APPLICATION

This application claims the benefit of U.S. Provisional Patent Application No. 60/922,053 filed Apr. 5, 2007 the entirety of which is hereby incorporated by reference into this application.

### BACKGROUND OF THE INVENTION

1. Field Of The Invention

The present invention relates to safety systems for mechanically moved edges and more particularly to a safety sensitive edge or photo-eye detector safety system with the ability to override a fault condition and permit movement of a mechanically moved edge, door or gate despite the fault condition.

2. Description Of The Related Art

Safety sensitive edges and control systems are used wherever moving edges represent a safety hazard for persons or objects. In particular, safety for moving edges is a major concern of users of automatic doors or gates. Thus, edge control systems including an operator and/or controller are utilized to ensure that a mechanically moved edge is stopped and/or reversed when an obstacle is encountered in order to prevent injury or damage to persons, animals or packages trapped at the mechanically moved edge. For example, a conventional safety sensitive edge is described in European patent EP 0 833 287 B1.

One type of safety sensing device is an electronic beam sensor. Photoelectric sensors are mounted just above the floor on both sides of a door or gate, send an invisible electromagnetic beam across the door or gate opening and are linked to the operator of a door or gate opener. If the beam is broken while the door or gate is closing, the operator will cause the door or gate to stop and reverse direction to a fully open position.

Another type of safety sensing device is a pressure-sensitive electronic rubber strip. The strip attaches to the floor contacting portion of the door or gate and includes a transmitter and a receiver mounted at opposite ends of a hollow elastic section in which a suitable signal, such as an ultrasonic, light or other electromagnetic wave signal is run. Interruption of the signal indicates an obstruction is contacted during the closing of the door or gate and, based on that signal interruption, the door or gate operator causes the door or gate to reverse direction to the fully open position. In a further alternative, two electrically conductive bands able to move with respect to one another are provided within the strip. If the strip encounters an obstruction and is deformed, the bands touch one another, generating a signal which the operator evaluates to cause the door or gate to stop and reverse to the fully open position to thereby prevent injury and/or damage. Thus, a feedback loop is established in or near the moving edge and a signal from the feedback loop used to control movement of the moving edge.

Conventional door or gate operators typically offer a constant pressure mode and/or a momentary contact mode. The operator is provided with a signal from an open/close/stop button which indicates whether the door or gate should be opened, closed or stopped from its current open/closed state or movement between states. The controller evaluates the open/close/stop signal to determine whether to generate a release signal, which can be used, for example, for controlling a driving mechanism for the door or gate. In the constant pressure mode, the open/close/stop button must be continuously depressed for the controller to generate the release signal which causes movement of the door or gate via the driving mechanism. In the momentary contact mode, the open/close/stop button need not be continuously depressed but need only be momentarily depressed for the operator to generate the release signal which causes movement of the door or gate. Then the door or gate will move until reaching its final position. When both modes are provided, the user is typically instructed how to change the operator mode, whether by a programmable software setting or a hardware setting, such as a dip switch or modification of existing wiring in the operator.

In a generic safety sensitive edge, the signal generated by the safety sensing device is linked to the door or gate operator. In addition to the signal indicating desired movement provided from the open/close/stop button, the operator is also provided and evaluates the signal(s) provided by the feedback loop or multiple loops to determine whether to generate the release signal. Conventional safety sensitive edges systems indicate over the release signal whether or not the door or gate can be moved safely.

Most external sensing edges and systems used in the commercial doors and gates are simple normal open contact (NOC) systems. For example, a two-wire modulated photo-eye, a two-wire electrical edge or a four-wire electrical edge can be used for safety sensing devices in a feedback loop. However, systems utilizing these type of safety sensing devices can not indicate whether the safety sensitive edge has responded because an object is encountered in the path of the closing door or gate or whether the signal from the edge, evaluated by the door or gate operator, indicates a fault because a component of the edge, such as a light transmitter or light receiver, is defective or has failed. For example, a broken wire can create an open circuit and generate a feedback signal that can not be distinguished from the feedback signal generated upon obstruction detection by a properly functioning edge system (i.e., a ‘true’ fault condition).

Even with periodic maintenance and adjustment, over time safety systems can fail due to external conditions such as physical damage). In the event an external sensing device fails and/or the link to the door or gate operator become inoperative, the operator will generate an output signal to indicate a potential unsafe condition and movement of the door or gate will not be permitted; the operator will prevent the operation of the moving edge of the door or gate. As in the case of an obstruction of the door or gate, the operator will thus force the fault to be cleared before allowing the closing of the door or gate via conventional use the operator. However, since an obstruction is not causing the fault condition, there is no obstruction to clear and thus no automatic way to mechanically close and secure the door or gate using the operator.

To close the door or gate under such a fault condition, the user may disconnect the door or gate operator and manually close the door or gate, or determine and disconnect the malfunctioning sensing device. In some installations, the operator provides the only means to close the door or gate if a manual door or gate closure method is not provisioned. In other installations, such a manual method may be extremely difficult and laborious, more so depending on the size and/or weight of the door or gate to be closed. In addition, disconnecting the sensing device is not recommended due to potential and on-going safety concerns.

Therefore, there is a need to provide a simple, easy method for using safety sensitive edges and control systems that will permit movement and mechanically assisted closing of a door or gate despite system failures of sensing devices, allowing override and bypass of the failure state.

### SUMMARY OF THE INVENTION

The present invention relates to a method, system and apparatus for operating a safety sensitive edge for the safeguarded motor-driven movement of a door or gate having a closing edge. External sensing device(s) arranged in a feedback loop are disposed in the moving edge of a door and generate a fault signal when an obstruction is detected or when components of the feedback loop have systemically failed. A button switch is depressed to indicate a user's desire to close or open the door or gate which generates a depressed button signal. The fault signal and depressed button signal are provided to a controller. In the absence of the fault signal, the controller generates an output signal indicating safe movement (e.g., closing of a door, opening of a swinging gate) is possible. If the fault signal is present, the controller generates an output signal indicating safe movement of the door or gate is possible only while the depressed button signal is provided to the controller. While the depressed status signal is provided to the controller and the fault signal is present, the controller may also generate a second output signal suitable to cause a change between the momentary contact and constant pressure closing modes in a conventional operator.

The method may be implemented in a stand-alone computer such as a programmable logic interface. The interface can be interposed between a conventional sensitive safety edge system and signals from one or more external safety sensing devices provided to the interface. The interface output signal indicating whether safe movement of the door is possible is provided to a conventional safety edge operator in place of the external safety sensing devices' fault status signal. A second output signal of the interface suitable to cause a change between the momentary contact and constant pressure closing modes in the conventional safety edge operator can also be provided. Alternatively, the method of the invention can be programmed within the conventional safety edge system operator or a general purpose computer for controlling a moving edge.

The invention will be more fully described by reference to the following drawings.

### BRIEF DESCRIPTION OF THE DRAWINGS

FIG. 1 is a schematic diagram of a safety sensitive edge system and its components with reference to a safeguarding closing edge in accordance with the teachings of the present invention in an exploded representation.

FIG. 2 is a schematic of a logic table detailing the control signal generated by an interface or operator in accordance with the teachings of the present invention.

FIG. 3 is a schematic diagram of a first embodiment of an interface in accordance with the teachings of the present invention.

FIG. 4 is a schematic diagram of a second embodiment of an interface in accordance with the teachings of the present invention.

FIG. 5 is a flow diagram of exemplary processing for operating a safety sensitive edge for the safeguarded movement of a moving edge according to the teachings of the present invention.

### DETAILED DESCRIPTION

Reference will now be made in greater detail to embodiments of the invention, examples of which are illustrated in the accompanying drawings. Wherever possible throughout course of this description, the same reference numerals will be used to identify the same or like elements.

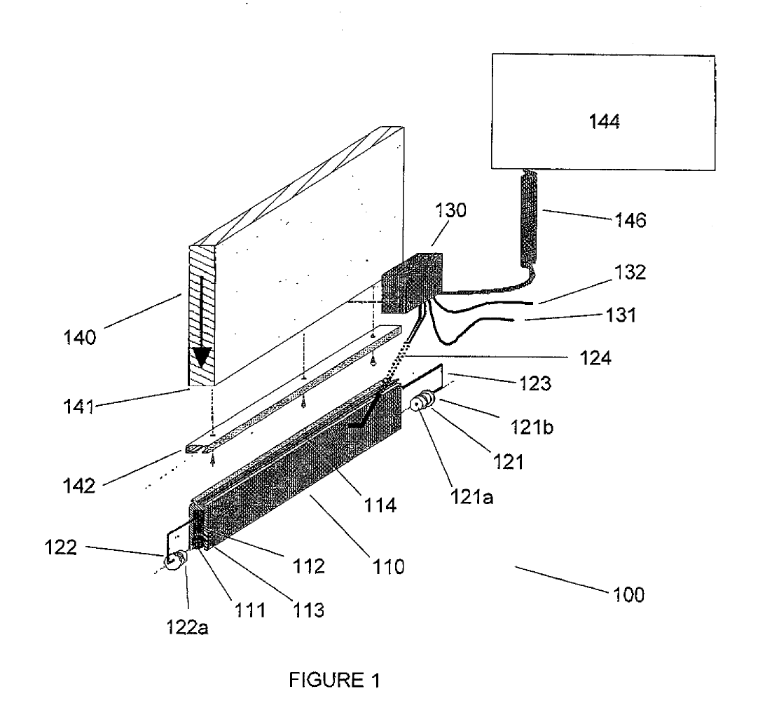

An embodiment of a safety sensitive edge system according to the invention for the safeguarded, motor-driven movement of a door or gate having a closing edge is shown in FIG. 1. In this illustrative embodiment, safety sensitive edge 100 is a generic, optoelectronic safety sensitive edge. Safety sensitive edge 100 is to be fastened to a door, gate or other moving edge 140. Safety sensitive edge 100 includes optical transmitter device 121 and optical receiver device 122, which are coupled over electric coupling lead 123 and the light path between the transmitter device and the receiver device, so that a feed-back loop is created. In a manner not shown, lead 124 connects electrical coupling lead 123 with controller 130.

In the example shown, safety sensitive edge 100 detects the deformation of hollow rubber profile 110. Hollow rubber profile 110 can be constructed rectangularly. Hollow rubber profile 110 preferably includes switch chamber 111 and a tracking chamber 112, both of which extend at a distance from one another along hollow rubber profile 110. Switching chamber 111 is constructed in the shape of a hollow cylinder. Optical transmitter device 121 is introduced at a first end of switching chamber 111 and corresponding optical receiver device 122 is introduced at the other end of switching chamber 111. The periphery of the transmitter device as well as that of the receiver device is fitted to the periphery of the switching chamber, so that these devices may simply be inserted into switching chamber 111.

Transmitter device 121 comprises light transmitter 121 a which can be in the form of an LED. An assigned transmitter control 121b triggers light transmitter 121a to emit light. In an appropriate manner, receiver device 122 comprises optical receiver 122a which can be in the form of a photodiode. Optical receiver 122a detects light emitted by the light transmitter 121a. Accordingly, an optoelectronic sensitive edge is provided in which light emitted by light transmitter 121a is taken up by receiver 122a and converted into electrical pulses and transmitted over electric coupling lead 123 back to transmitter device 121. Accordingly, a feedback loop is provided.

The above description of an optoelectronic sensitive edge is only representative of illustrative examples of embodiments and implementations of a sensitive edge system using an external sensing device. Edge systems employing other external sensing devices such as alternative optical sensing edges (OSE), pressure sensitive devices, ultrasonic wave signal or various other electromagnetic wave signal devices are alternatives that can be used in the system contemplated by the invention. In addition, multiple external sensing devices can be provided in the door or gate and/or external sensing devices for providing obstruction detection can be disposed in the wall of the passageway provided by the door or gate. The signals generated by additional external sensing devices are provided to controller 130 via additional leads.

On the longitudinal side that faces closing edge 141 of the door, gate moving edge, hollow rubber profile 110 has two link plates 114. Link plates 114 can be laterally inserted in C profile 142. C profile 142 is fastened to closing edge 141 of the gate by screws or other suitable means.

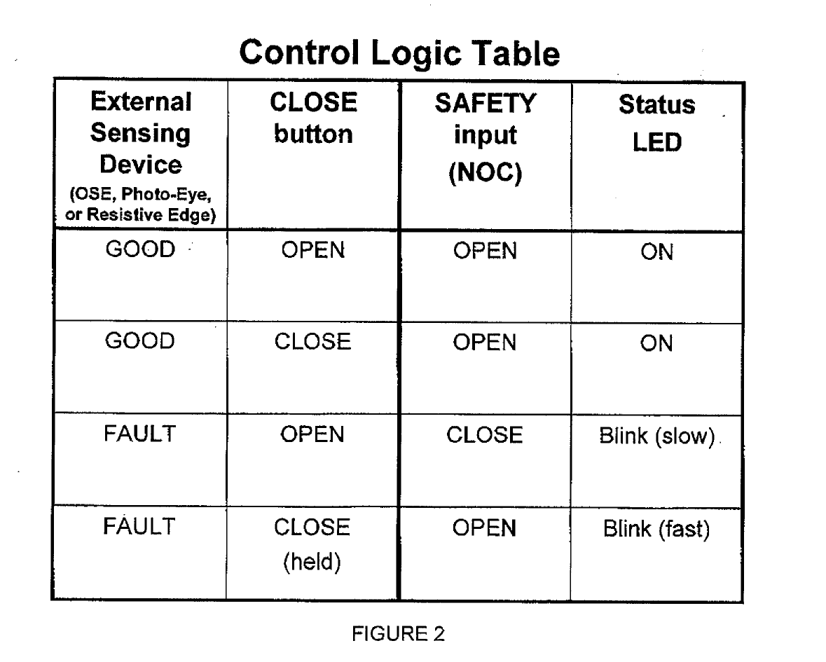

As described above, the dynamic electric coupling signal from electric coupling lead 123 is tapped by lead 124 and taken to controller 130, which works as a central control device. Controller 130 is also provided a signal from open/close/stop button 144 via lead 146. Controller 130 evaluates the signals provided by safety sensing edge 100 and open/close/stop button 144 according to the control logic detailed in FIG. 2 and generates, causes, provides output signal 131 referred to as the safety input signal. Accordingly the invention, the safety input signal indicates by its status whether or not the door or gate can be safely moved. Controller 130 can also include a LED via which visual indication of the current status of the safety input signal is provided to the user.

Controller 130 can be implemented in a stand alone aftermarket version that may be utilized with conventional sensitive safety edge systems. Such a controller is interposed to a conventional sensitive safety edge system and provided signals from the external sensing device(s) and open/close/stop button 144. The controller can be a programmable logic controller or other computerized logic device or interface capable of receiving input signals and generating an output signal based on an evaluation of the input signals provided. The controller can also take the form of a microcomputer or a general purpose computer incorporating a microprocessor or a central processing unit utilizing known hardware and software technology. The central processing unit may be a personal computer, thin-client computer, PDA, laptop, tablet computer, or any other suitable computing device.

The invention is described with reference to methods, apparatuses and computer program products according to illustrative embodiments. This invention may, however, be embodied in many different forms and should not be construed as limited to the embodiments set forth herein; rather, the illustrative embodiments provide a thorough and complete disclosure, fully conveying the scope of the invention to those skilled in the art. It will be understood that each step of the method, and accommodations for each step of the method, respectively, can be implemented by computer program instructions, analog and/or digital logic gates and other signal evaluation means or some combination thereof. These computer program instructions may be loaded onto one or more general purpose computers, special purpose computers, or programmable data processing apparatus to produce machines, such that the instructions which execute on the computers or other programmable data processing apparatus create means and apparatuses for implementing the functions specified. Such computer program instructions may also be stored and/or loaded in a computer-readable memory that can direct a computer or other programmable data processing apparatus to function in a particular manner or cause a series of operational steps to be performed, such that the instructions stored in the computer-readable memory produce an article of manufacture including instruction means that implement the functions specified and described herein.

The electric coupling signal from the external sensing devices is evaluated at controller 130 in conjunction with open/close/stop button signal and, in response to those signals, that is, depending on the coupling signal and the close button signal detected, the safety input signal is generated and put out over controller 130 output signal lead 132. The safety input signal from output signal lead 132 is then provided to a conventional door or gate operator in place of the signal(s) from the external sensing device(s). The conventional operator evaluates the safety input signal to determine whether to generate a release signal. Further, the controller may also generate a second output signal suitable to cause a change between the momentary contact and constant pressure closing mode at the conventional door or gate operator.

Alternatively, a sensitive safety edge system according to the invention may use a single controller, microcomputer or computing device, the single device provisioned with the logic of the inventive method in addition to conventional door or gate operator logic. For example, such controller 130 would include logic to implement a constant pressure mode and/or a momentary contact mode. The controller evaluates the electric coupling signal from the external sensing device(s) in conjunction with close button signal and, in response to those signals, that is, depending on the coupling signal and the close button signal detected, the safety input signal is generated by controller 130. The safety input signal is then used internally by controller 130 and again in conjunction with the signal from the close button to generate a release signal indicating the open/close state of the door or gate is to be adjusted. The release signal is put out over the output signal lead 132. Internally, the single controller embodiment may also cause a change in the closing mode from momentary contact mode to constant pressure mode.

The output signal 132 of the safety edge 100 can be taken, in a manner not shown, to a control system for the door or gate driving mechanism, which evaluates the signal, for example, in order to move the door or gate further in the closing direction as requested by the release signal, or to stop or reverse the door or gate, when actuation of the safety sensitive edge (i.e., fault condition) is detected. A fault condition occurs if, during the movement of closing edge 141, the edge is moved against an obstacle, and hollow profile 110 which comes up against the obstacle is deformed.

The user can close the door or gate normally (i.e., momentary contact, radio controls, etc.) when the sensing devices are working properly. In the event of a fault condition caused by an obstacle impeding the closing edge, the closing edge will stop or reverse when actuation of the safety sensitive edge (i.e., fault condition) is detected. However, a fault condition also occurs if the external sensing device(s) and/or leads providing signal(s) therefrom have suffered a component failure. In the event the sensing devices are not working properly or the interface or controller can not verify the sensing devices are working properly, that state of failure preventing the door or gate from being closed can be overridden by holding the open/close/stop button. In such a situation, a user is able to override the fault condition and generate a safety input signal indicating the door or gate can be safely closed despite the fault condition caused by systemic failures.

For the reader's convenience, the above description has focused on a representative example of all possible embodiments, a sample that teaches the principles of the invention. Other embodiments may result from a different combination of portions of different embodiments. The description has not attempted to exhaustively enumerate all possible variations.

FIG. 2 is a logic table detailing the safety input signal generated by a controller in accordance with the invention. Based on conventional signals provided by the safety sensing devices associated with the moving edge and the status of the open/close/stop button, a safety input signal is generated by the controller. The safety input signal indicates by its status whether or not the door or gate can be safely moved further. The safety input signal may be utilized by a conventional door or gate operator in conjunction with evaluation of an open/close/stop button signal to generate a release signal for the driving mechanism of the door or gate.

External sensing devices such as OSE, photo-eye or resistive edge, are used to generate a signal indicating whether or not an obstruction was encountered while closing the door or gate. As mentioned above, if the external sensing device and/or its link to the controller have failed, a signal indistinguishable from the signal indicative of an encountered obstruction is generated. Therefore, according to the invention, the first signal from the external sensing device is evaluated in conjunction with second signal from the open/close/stop button to determine whether the door or gate may be closed safely despite the first signal indicating an encountered obstruction. A first output signal is generated if the moving edge can be closed safely and a second output signal is generated otherwise. A status LED on the controller can also be provided to visually communicate state information for the controller.

If the signal from the external sensing device(s) indicates that there is no obstruction (i.e., External Sensing Device signal is GOOD) and the open/close/stop button is not being selected/depressed (i.e., Close Button signal is OPEN), the controller generates a safety input signal that indicates that the door or gate may be closed safely (i.e., Safety input is OPEN). The status LED indicates this controller state by remaining continuously on or energized.

If the signal from the external sensing device(s) indicates that there is no obstruction (i.e., External Sensing Device signal is GOOD) and the open/close/stop button is depressed/selected (i.e., Close Button signal is CLOSE), the controller generates a safety input signal that indicates that the door or gate may be closed safely (i.e., Safety Signal is OPEN). Again, the status LED indicates this controller state by remaining continuously lit or energized.

The invention departs from conventional systems in its treatment of fault conditions signaled by the external sensing device(s). If the signal from the external sensing device(s) is indicative of an obstruction (i.e., External Sensing Device signal is FAULT) and the open/close/stop button is not selected/depressed (i.e., Close Button signal is OPEN), the controller generates a safety input signal that indicates that the door or gate may not be closed safely (i.e., Safety Signal is CLOSE). The status LED indicates this controller state by blinking slowly.

If the signal from the external sensing device(s) indicates that there is an obstruction (i.e., External Sensing Device signal is FAULT) and the open/close/stop button is being continuously depressed/selected (i.e., Close Button signal is CLOSE (held)), the controller generates a safety input signal that indicates that the door or gate may be closed safely (i.e., Safety Signal is OPEN). The status LED indicates this controller state by blinking fast. In this situation, the controller may also generate a second output signal that directs a conventional operator to switch between the momentary contact and constant pressure closing modes.

In this manner, if an obstruction is encountered when closing the door or gate, a safety input signal is generated that indicates such obstruction. If a failure of an external sensing device has occurred, a safety input signal indicative of an obstruction is also generated. However, after confirmation of the absence of a ‘true’ fault condition, a safety input signal indicating an obstruction can be overridden by continuous depression of the open/close/stop button.

A door, gate or moving edge can be operated in a conventional manner despite system failures in the external sensing device(s) when the open/close/stop button is selected and such selection continuously held. It may be additional required that the open/close/stop button be held for a any predetermined period of time, for example one (1)-five (5) seconds, before the safety input signal is initially generated, thereby permitting operating of the moving edge. Thus, a purposeful decision to close the door or gate must be made; if the open/close/stop button is accidentally selected, the safety input signal will not be initially generated until the passage of the predetermined time period. Naturally, it would be expected that a user would not attempt to override the fault condition indicated by the external sensing device if an obstruction of the door or gate is present and/or visible and only attempt an override after a thorough check of the safety sensitive edge system.

Under a fault condition from the external sensing device, when the open/close/stop button is not selected or is selected and such selection not continuously held, the safety input signal that is generated indicates that the door or gate can not be operated safely. Thus, if the user releases the selection of the open/close/stop button at any time prior to completion of the closing of the door or gate, a safety input signal that permits further movement of the door will no longer be generated.

In this manner, the method provided by the invention allows for the operation of safety sensitive edge systems having a constant pressure mode and/or a momentary contact mode. When the open/close/stop button is selected and there is no obstruction, a safety input signal is generated to indicate that the door or gate can be operated safely. The controller can use that safety input signal internally and depending on the mode of the closing system and further signal from the open/close/stop button, the door or gate may be closed. Alternatively, the controller can provide that safety input signal externally and the safety input signal provided to a conventional system for safeguarded movement of a door or gate having a closing edge in place of standard sensing device input without corrupting the conventional system's operation.

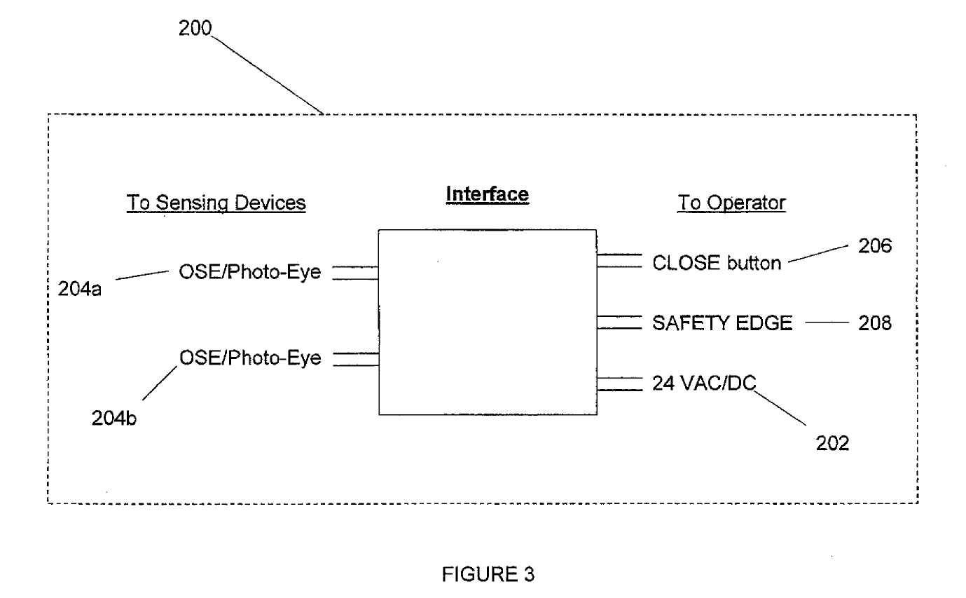

FIG. 3 is a view of a controller/interface 200 for an embodiment in accordance with the invention. Power 202 is supplied to controller/interface 200. For illustrative purposes a 24 V AC/DC line is shown though power may be supplied in various forms via various known means. The illustrated interface receives two wire OSE/photo eye signals 204a,204b from the safety sensing devices deployed in the moving edge and/or passageway provided by the door or gate. Signals are received from two safety sensing devices in the illustration however, any number and type of sensing devices may be provided in the system of the invention and signals from those safety devices supplied to controller/interface 200. The safety sensing devices indicate whether or not an obstruction is encountered or will be encountered by the moving edge.

Controller/interface 200 also receives, via the operator, a signal (i.e., CLOSE button) from open/close/stop button 144 that indicates when the button is depressed. Controller/interface 200 evaluates the received OSE/photo eye signals 204a,204b and the open/close/stop signal according to the control logic of FIG. 2. Based on the logic applied to the received signals, safety edge input signal 208 is generated and provided to a conventional operator. Safety input signal 208 indicates by its status whether or not the door or gate can be safely moved further. The conventional door or gate operator evaluates the safety input signal instead of the OSE/photo eye signals 204a,204b and determines a release control signal used for controlling the driving mechanism of the door or gate.

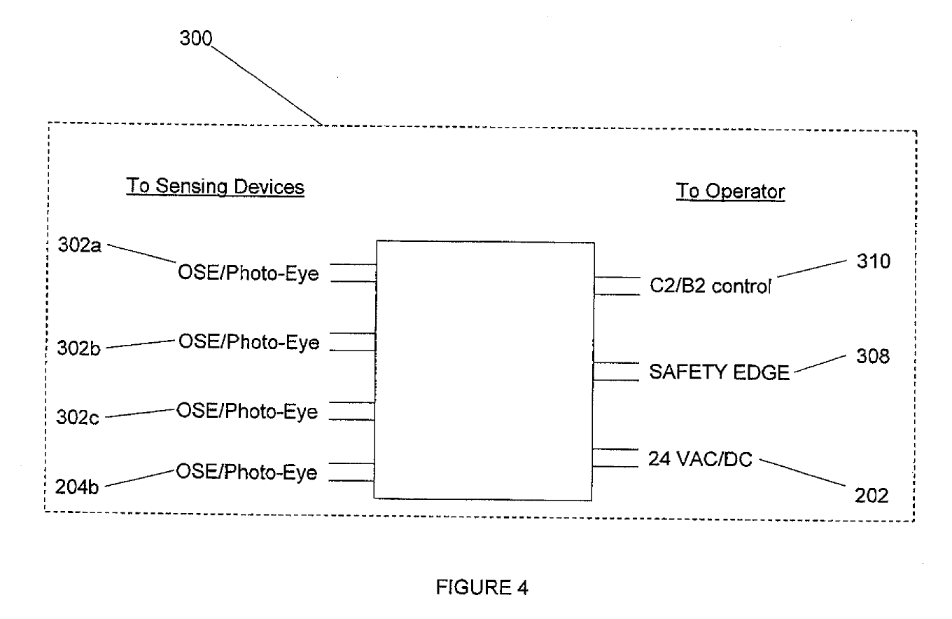

FIG. 4 is a view of a second embodiment of controller/interface 300 in accordance with the teachings of the present invention. Signals 302a-302d from four safety sensing devices deployed proximate the moving edge, door or gate are provided to controller/interface 300 and indicate an obstruction of the moving edge. The sensing devices may be of any number and type though signals from four two wire OSE/photo eyes are illustrated. A signal indicating the state of the open/close/stop button (not shown) is also provide to controller/interface 300. Based on an evaluation of the received sensing device signals and the open/close/stop signal, controller/interface 300 determines safety edge signal 308 according to the previously described method and outputs that signal. Safety edge signal 308 indicates whether the moving edge can be safely moved further and is provided to a conventional operator instead of the safety device signals. Controller/interface 300 also provides signal 310 suitable to toggle the conventional operator between the momentary contact close mode and the constant pressure close mode (C2/B2). A conventional operator utilizes these provided signals to determine a release control signal used for controlling the driving mechanism of the moving edge. The controller of the invention may be embodied stand-alone model or may be integrated within a conventional operator.

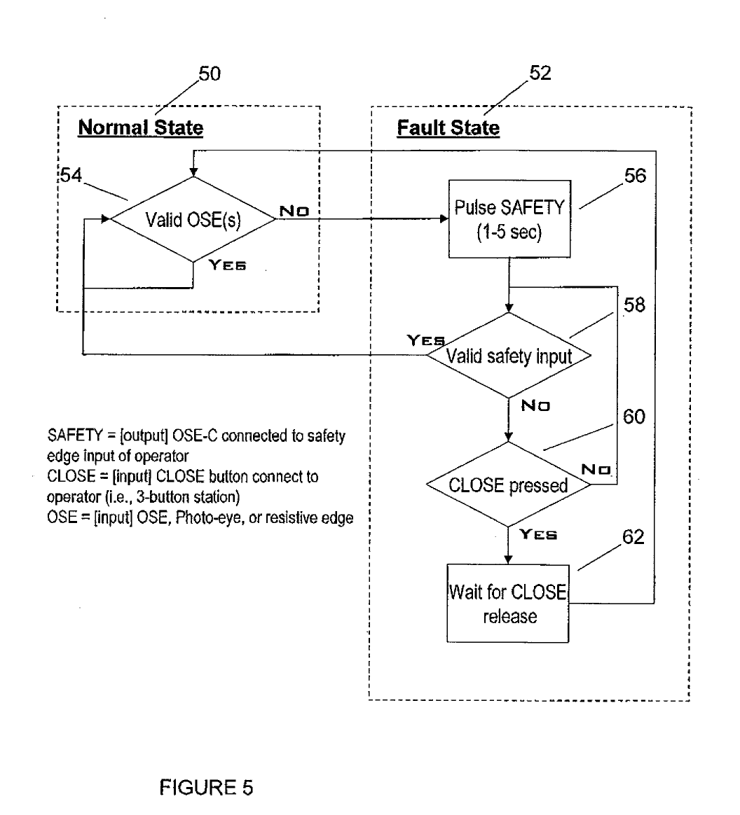

FIG. 5 is a flow diagram of exemplary processing for operating a safety sensitive edge for the safeguarded movement of a moving edge according to an implementation consistent with the principles of the present invention. In this implementation, the controller has two states, normal state 50 and fault state 52. Initially, the controller is in normal state 50. Signal(s) received from the safety sensing device(s) proximate the moving edge are evaluated in block 54. If valid signal(s) indicating no perceived obstruction of the moving edge are received from the safety sensing device(s), the controller remains in the normal state, looping to again check the signal(s) received from the safety sensing device(s). If an invalid signal indicating a perceived obstruction of the moving edge is detected, the controller enters fault state 52. Upon entering fault state 52, a safety signal indicating that the moving edge can not be safely moved further is generated in block 56. The safety signal may be a signal pulsed for any number of seconds. For example, the safety signal may be a one to five second pulse. As, the safety signal is provided to a conventional operator in place of the signal(s) from the safety sensing device(s), the pulse of the safety signal prevents operation of the moving edge.

Continuing in the fault state, the validity of the safety signal is then evaluated in block 5). If the safety signal is not valid, as it will be upon initial entry into the fault state, the status of the open/close/stop button is evaluated in block 60. A user can depress the open/close/stop button to override the fault state and order movement of the moving edge despite the fault condition indicated by the safety sensing device(s). If the open/close/stop button is not pressed, the exemplary processing method loops to again check the validity of the safety signal in block 58. If the safety signal is valid, such as after the safety signal times out, the method returns to normal state 50. If the signal(s) from the safety sensing device(s) is invalid indicating an obstruction is still perceived, the fault state is again entered, pulsing the safety signal and preventing movement of the edge. However, if the signal(s) from the safety sensing device(s) is valid, such as after an obstruction of the moving edge is cleared or systemic failures have been corrected, the method remains in the normal state. Accordingly, after detection of an obstruction and prevention of the movement of the moving edge, if the obstruction is thereafter cleared, operation of the moving edge is permitted in a conventional manner.

Otherwise, if the obstruction indicated by the safety sensing device(s) can not be cleared, that fault condition indicated by the safety sensing device/can be overridden to allow movement of the moving edge. In the fault state, once the safety signal is asserted and the open/close/stop button is pressed, the method waits until the open/close/stop button is released in block 62 and thereafter returns to normal state 50. If the open/close/stop button is depressed for a period of time greater than the remaining pulse of the safety signal, the pulse of the safety signal will time out. Once the pulse of the safety signal times out, the safety signal is no longer asserted and motion of the moving edge will be permitted by the conventional operator provided the safety signal. If the open/close/stop button is released and the safety signal remains invalid indicating an obstruction of the moving edge, fault state 52 is entered and the safety signal pulsed. Assertion of the safety signal indicates continued movement of the moving edge should be prevented by the conventional operator.

Block 62 can also include a reset of the safety signal pulse to a predetermined time period. In that case, a user must purposefully hold the open/close/stop button depressed longer that the pulse of the safety signal before movement of the moving edge is permitted and once the button is released, movement of the edge is prohibited if the safety sensing device(s) continue to indicate an obstruction. For example, block 62 may reset the safety signal pulse to three seconds to ensure that the open/close/stop button is depressed for three seconds before override of the fault condition and movement of the edge is permitted. Whether any signal is indicated by a 0 or 1, open or closed circuit, assertion or non assertion is immaterial to the invention as the logic of the invention is adaptable to any signal standard.

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention. Details of the structure may be varied substantially without departing from the spirit of the invention and the exclusive use of all modifications, which come within the scope of the appended claim, is reserved.

What is claimed is:

1. An interface for controlling the safeguarded motor-driven movement of a door or gate having a moving edge, the interface comprising:
a first input port for receiving a first status signal;
a second input port for receiving a second status signal; and
an evaluation device operative to generate a first output signal in response to receipt of the first status signal and, in response to absence of the first status signal, to generate the first output signal in response to receipt of the second status signal.

2. The interface for controlling the safeguarded motor-driven movement of a door or gate having a moving edge of claim 1, the interface further comprising:
an output port for providing the first output signal external to the interface.

3. An interface for controlling the safeguarded motor-driven movement of a door or gate having a moving edge, the interface comprising:
a first input port for receiving a first status signal;
a second input port for receiving a second status signal; and
an evaluation device operative to evaluate the first status signal and the second status signal and to generate a first output signal, each signal having a first state and a second state, wherein the first state of the first output signal is generated in response to the first state of the first status signal, and wherein in response to the second state of the first status signal, the first state of the first output signal is generated in response to the first state of the second status signal and the second state of the first output signal is generated in response to the second state of the second status signal.

4. An interface for controlling the safeguarded motor-driven movement of a moving edge in a path, the interface comprising:
a first input port for receiving an external sensing device status signal indicating obstruction or no obstruction in the path of the moving edge;
a second input port for receiving a user status signal indicating request or no request for movement of the moving edge; and
an evaluation device operative to evaluate the external sensing device status signal and the button status signal and to generate a safety signal,
wherein the safety signal indicates movement is permitted when the external sensing device status signal indicates no obstruction of the path, and
wherein if the external sensing device status signal indicates obstruction of the path, the safety signal indicates movement is permitted when the user status signal indicates request for movement and the safety signal indicates movement is not permitted when the user status signal indicates no request for movement.

5. An interface for controlling the safeguarded motor-driven movement of a moving edge in a path, the interface comprising:
a first input port for receiving an external sensing device status signal indicating obstruction or no obstruction in the path of the moving edge;
a second input port for receiving a user status signal indicating request or no request for movement of the moving edge; and
an evaluation device operative to evaluate the external sensing device status signal and the button status signal and to generate a safety signal,
wherein the safety signal indicates movement is permitted when the external sensing device status signal indicates no obstruction of the path, and
wherein if the external sensing device status signal indicates obstruction of the path, the safety signal indicates for at least a predetermined period of time that movement is not permitted, and thereafter upon receipt of the user status signal indicating request for movement, the safety signal indicates movement is permitted so long as the user status signal indicates request for movement.

6. A safety sensitive edge system for the safeguarded motor-driven movement of a door or gate having a moving edge, the safety sensitive edge system comprising:
an external sensing device, the external sensing device generating a first status signal if no obstruction is perceived in a path of the moving edge;
a button switch, the button switch generating a second status signal when the button switch is depressed; and
a first controller, the first controller operative to evaluate the first status signal and the second status signal, and in response to the first status signal to generate a first output signal, the first controller further operative to generate the first output signal in response to the second status signal in the absence of the first status signal.

7. The safety sensitive edge system for the safeguarded motor-driven movement of a door or gate having a moving edge according to claim 6 wherein the external sensing device is an optical photo-eye.

8. The safety sensitive edge system for the safeguarded motor-driven movement of a door or gate having a moving edge according to claim 6 wherein the external sensing device is a resistive edge.

9. The safety sensitive edge system for the safeguarded motor-driven movement of a door or gate having a moving edge according to claim 6 wherein the external sensing device is a optoelectronic edge.

10. The safety sensitive edge system for the safeguarded motor-driven movement of a door or gate having a moving edge according to claim 6 further comprising a door, the external sensing device attached to or proximate a bottom edge of the door.

11. The safety sensitive edge system for the safeguarded motor-driven movement of a door or gate having a moving edge according to claim 10 further comprising mechanical means for moving the door, the mechanical means responsive to the release signal.

12. The safety sensitive edge system for the safeguarded motor-driven movement of a door or gate having a moving edge according to claim 6 further comprising
a second controller, the second controller operative to evaluate the first output signal and the second status signal and to generate a release signal.

13. The safety sensitive edge system for the safeguarded motor-driven movement of a door or gate having a moving edge according to claim 12 wherein the first controller and the second controller are the same controller.

14. The safety sensitive edge system for the safeguarded motor-driven movement of a door or gate having a moving edge according to claim 6 wherein the controller is further operative to provide a momentary contact close mode and a constant pressure close mode.

15. The safety sensitive edge system for the safeguarded motor-driven movement of a door or gate having a moving edge according to claim 6 wherein the controller generates a second output signal after receipt of the first status signal, the second output signal indicating a program change between a momentary contact close mode and a constant pressure close mode.

16. A safety sensitive edge system for the safeguarded motor-driven movement of a door or gate having a moving edge, the safety sensitive edge system comprising:
an external sensing device, the external sensing device generating a first status signal if an obstruction is perceived in a path of the moving edge;
a button switch, the button switch generating a second status signal when the button switch is depressed; and
a first controller, the first controller operative to evaluate the first status signal and the second status signal and to generate a first output signal, the first output signal having a first state and a second state,
the first state of the first output signal being generated in an absence of first status signal,
the second state of the first output signal being generated for a predetermined time after receipt of the first status signal, and after the second status signal is detected, being generated for a predetermined time after the second status signal is not detected if the first status signal is detected.

17. A method for operating a safety sensitive edge for the safeguarded motor-driven movement of a moving edge, the method comprising:
receiving a first status signal, wherein the first status signal is in a first state if a fault is not perceived at an external sensing device, and wherein the first status signal is in a second state if a fault is perceived at an external sensing device;
receiving a second status signal wherein the second status signal is in a first state if a switch is depressed, and wherein the second status signal is in a second state if a switch is not depressed;
generating a first output signal, wherein the first output signal is generated in a first state if the first status signal is in its first state;
and wherein if the first status signal is in its second state, the first output signal is generated in a second state if the second status signal is in its second state and the first output signal is generated in its first state if the second status signal is in its first state.

18. The method for operating a safety sensitive edge for the safeguarded motor-driven movement of a moving edge according to claim 17, wherein generating the first output signal in its first state if the first status signal is in its second state occurs only after the second status signal has been received in its first state or a predetermined time.

19. A method for operating an safety sensitive edge for the safeguarded motor-driven movement of a moving edge, the method comprising:
receiving an external sensing device status signal indicating perceived obstruction or no perceived obstruction in the path of the moving edge;
receiving a user status signal indicating request or no request for movement of the moving edge;
generating a safety signal indicating movement is permitted when the external sensing device status signal indicates no obstruction of the path, and
generating a safety signal indicating movement is permitted when the external sensing device status signal indicates obstruction of the path and the user status signal indicates request for movement;
generating a safety signal indicating movement is not permitted when the external sensing device status signal indicates obstruction of the path and the user status signal indicates no request for movement.

20. The method for operating an safety sensitive edge for the safeguarded motor-driven movement of a moving edge of claim 19 wherein generating a safety signal indicating movement is permitted when the external sensing device status signal indicates obstruction of the path and the user status signal indicates request for movement occurs only after the user status signal indicates request for movement for a predetermined time.

21. A method for operating a safety sensitive edge for the safeguarded motor-driven movement of a moving edge, the method comprising:
monitoring a first status signal;
monitoring a second status signal; and
generating a first output signal if the first status signal does not suggest a fault condition; and
generating the first output signal if the first status signal suggest a fault condition and the second status signal suggests an override of the fault condition.

22. A method for operating a safety sensitive edge for the safeguarded motor-driven movement of a moving edge, the method comprising:
monitoring a first status signal for a fault condition;
monitoring a second status signal for an override condition;
providing a safety signal indicating motion is permitted if the fault condition is not detected;
providing a safety signal indicating motion should be prevented if the fault condition is detected; and
overriding the safety signal indicating motion should be prevented and providing the safety signal indicating motion is permitted if after the fault condition is detected, the override condition is detected.

23. A method for operating an safety sensitive edge for the safeguarded motor-driven movement of a moving edge, the method comprising:
receiving an external sensing device status signal indicating obstruction or no obstruction in the path of the moving edge;
receiving a user status signal indicating request or no request for movement of the moving edge; and
providing a safety signal,
wherein the safety signal indicates movement is permitted when the external sensing device status signal indicates no obstruction of the path, and
wherein if the external sensing device status signal indicates obstruction of the path, the safety signal indicates movement is permitted if the user status signal indicates request for movement and the safety signal indicates movement is not permitted if the user status signal indicates no request for movement.

24. A method for operating a safety sensitive edge for the safeguarded motor-driven movement of a moving edge, the method comprising:
receiving a first status signal indicating the status of an external sensing device;
receiving a second status signal indicating the status of a switch;
evaluating the first status signal and the second status signal and causing a first output signal; wherein the first output signal indicates the moving edge can be safely closed if the first status signal indicates no obstruction of the moving edge or, if the first status signal indicates obstruction of the moving edge, the first output signal indicates the moving edge can be safely closed if the second status indicates that the switch is being depressed.

25. The method for operating a safety sensitive edge for the safeguarded motor-driven movement of a moving edge of claim 24, the method further comprising:
generating the first status signal indicating obstruction of the moving edge when obstruction of the moving edge is perceived.

26. The method for operating a safety sensitive edge for the safeguarded motor-driven movement of a moving edge of claim 24, the method further comprising:
generating the second status signal indicating that a switch is depressed when the switch is depressed.

27. A method for operating a safety sensitive edge for the safeguarded motor-driven movement of a moving edge, the method comprising:
evaluating the first status signal and the second status signal; and
generating a first output signal; wherein the first output signal indicates a door can be safely closed if the first status signal indicates no obstruction of the door and the first output signal indicates a door can be safely closed if the first status signal indicates obstruction of the door and the second status signal indicates that the switch is being depressed.

29. A method for operating an safety sensitive edge for the safeguarded motor-driven movement of a moving edge, the method comprising:
generating a first status signal if a fault is detected at an external sensing device;
providing the first status signal to a controller;
generating a second status signal if a switch is depressed;
providing the second status signal to the controller;
evaluating the first status signal and the second status signal and generating a first output signal in the absence of the first status signal, or if the first status signal is provided, when the second status signal is provided.

30. A method for operating an optoelectronic safety sensitive edge for the safeguarded motor-driven movement of a gate having a moving edge, the method comprising:
emitting light dynamically from a light transmitter device having a light transmitter and a transmitter control system;
guiding the emitted light to a light receiver device;
generating a first electrical coupling signal in response to the light received;
passing the first electrical coupling signal to a controller;
generating a second electrical coupling signal when a button is depressed;
passing the second electrical coupling signal to a controller; and
generating a safety input signal in response to the first electrical coupling signal and the second electrical coupling signal; wherein safety input signal indicates a door can be safely closed when the first electrical coupling signal indicates no obstruction of the door or if the first electrical coupling signal indicates obstruction of the door, when the second electrical coupling signal indicates that the button is being depressed.

31. A computer-usable medium having computer readable instructions stored thereon for execution by a processor to perform a method comprising:
receiving a first status signal, wherein the first status signal is in a first state if a fault is not perceived at an external sensing device, and wherein the first status signal is in a second state if a fault is perceived at an external sensing device;
receiving a second status signal wherein the second status signal is in a first state if a switch is not depressed, and wherein the second status signal is in a second state if a switch is not depressed;
generating a first output signal, wherein the first output signal is in a first state if the first status signal is in the first state;
and wherein if the first status signal is in the second state, the first output signal is in a second state if the second status signal is in the second state and the first output signal is in the first state.

32. A method of safeguarding movement of a moving edge; the method comprising
evaluating in a normal state a sensing signal received from a safety sensing device proximate the moving edge;
providing a safety signal indicating movement of the moving edge is permitted if the sensing signal indicates no obstruction of the moving edge, otherwise entering a fault state and generating a safety signal indicating movement of the moving edge is precluded;
evaluating the safety signal in the fault state, and entering the normal state if the safety signal is valid, otherwise evaluating a button status signal and if the button status signal is not pressed, evaluating the safety signal, otherwise waiting until the button is released and then returning to the normal state.
